(19) United States
(12) Patent Application Publication
(10) Pub. No.: US 2013/0090595 A1
(43) Pub. Date: Apr. 11, 2013

(54) INFANT MEDICINE DISPENSER

(71) Applicant: Veronica Brenner, Coto de Caza, CA (US)

(72) Inventor: Veronica Brenner, Coto de Caza, CA (US)

(21) Appl. No.: 13/267,785

(22) Filed: Oct. 6, 2011

(51) Int. Cl. A61J 7/00; A61J 17/00

(52) U.S. Cl. 604/77

(57) ABSTRACT

An infant medicine dispenser may have a pacifier and a cover. The pacifier may be formed with an opening at a distal tip of a nipple of the pacifier. The nipple of the pacifier may also be hollow to store liquid medicine to be administered to an infant. The opening at the distal tip of the nipple may form a generally liquid tight seal which holds the liquid medicine within the interior reservoir of the nipple, but allows the liquid medicine to flow there through upon sucking. The back side of the pacifier may have an opening through which the liquid medicine is poured into the interior reservoir. The opening may be sealed with a cover to prevent spills if the infant medicine dispenser is inadvertently knocked out of the infant's mouth.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The embodiments disclosed herein relate to a device for dispensing medicine to an infant.

Administering a liquid medicine to an infant can be frustrating and often times messy. Prior art methods of administering liquid medicine to the infant include a syringe, dropper and small spoon. Unfortunately, the liquid medicine may have a taste which is offensive to the infant, so that the infant spits out the liquid medicine immediately upon administration. Another deficiency in prior art devices for administering medicine to infant is that it is difficult to gage the amount of liquid medicine that has already been administered to the infant if the infant spits out a portion of the liquid medicine inserted into the infant's mouth.

Accordingly, there is a need in the art for an improved infant medicine dispenser.

### BRIEF SUMMARY

The embodiments disclosed herein address the needs discussed above, discussed below and those that are known in the art.

An infant medicine dispenser may be shaped as a pacifier with a distal tip having a sealable opening. Normally, the opening is sealed so that liquid medicine may be stored in a reservoir in the nipple prior to administration to the infant. An opening behind the nipple allows the user to fill the liquid medicine in the reservoir. A cover may be inserted into the opening to provide a liquid tight seal and to prevent inadvertent spills when the infant medicine dispenser is inadvertently knocked out of the user's hand or knocked out of the infant's mouth. To administer the liquid medicine, the user inserts the nipple into the infant's mouth. The infant's sucking reflex is triggered so that the opening at the distal tip of the nipple is opened and the liquid medicine flows there through into the infant's mouth. The infant continues to suck on the infant medicine dispenser so that the infant swallows the liquid medicine. The cover may create a generally air tight seal with the opening so that suction is created when the infant sucks on the nipple. This may also encourage the infant to continue sucking on the nipple and swallow the liquid medicine.

More particularly, an infant medicine dispenser is disclosed. The dispenser may comprise a pacifier and a cover. The pacifier may define a nipple and a flange. The flange may be attached to a base of the nipple. The nipple may have a slit at a distal tip of the nipple. The nipple may have an interior reservoir with an opening opposite the distal tip of the nipple. The slit may form a generally liquid tight seal so that liquid medicine stored in the reservoir does not leak out of the nipple while filling the reservoir with the liquid medicine and while the infant latches onto the nipple.

The cover may be sized and configured to plug an opening leading to the reservoir so that the liquid medicine does not spill if the pacifier is inadvertently dislodged from the infant's mouth. The liquid medicine generally flows out of the reservoir into the infant's mouth after the infant latches onto the nipple and begins to suck on the nipple.

The slit may be a single straight slit, a single curved slit or a cross slit. If the slit is the single straight slit, then the single straight slit may be positioned vertically in the infant's mouth so that the single straight slit opens up when the infant begins to suck on the nipple. More particularly, the single straight slit may open up when the infant compresses the nipple with his/her tongue and a top of the infant's mouth during the sucking process. If the slit is the cross slit, then the cross slit may open up when the infant begins to suck on the nipple regardless of an angular orientation of the nipple. If the slit is the single curved slit, then the single curved slit may open up when the infant begins to suck on the nipple regardless of an angular orientation of the nipple.

The cover may be removably attached to the opening of the nipple. Alternatively, the cover may be integral with the pacifier. By way of example and not limitation, the cover may have a slit which is normally closed and capable of being traversed to an opened position by squeezing the pacifier.

The interior reservoir of the nipple may hold three (3) ml. The nipple may be semi transparent to transparent. The nipple may have graduations for indicating an amount of liquid medicine in the nipple. The level of the liquid medicine may be seen through the nipple.

The opening of the interior reservoir may have threads. The dispenser may further have an extension tube threadably engageable to the threads of the opening of the interior reservoir to enlarge a capacity of the interior reservoir. The cover may be removably attached to a proximal end of the tube.

The tube may extend past the flange opposite the nipple. The tube may also have graduations for indicating an amount of liquid medicine in the nipple and the tube. Alternatively, the tube may be integrally formed with the flange on an opposite side of the nipple to enlarge a capacity of the interior reservoir.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a front perspective view of an infant medicine dispenser;

FIG. 2 is a rear perspective view of the infant medicine dispenser shown in FIG. 1;

FIG. 3 is a plan view of the infant medicine dispenser shown in FIG. 1;

FIG. 4 is an embodiment of a slit formed at a distal end of a nipple of the infant medicine dispenser shown in FIG. 3;

FIG. 5 is an alternate embodiment of the slit shown in FIG. 4;

FIG. 6 is an alternate embodiment of the slit shown in FIG. 4;

FIG. 7 is an alternate embodiment for a means for allowing liquid medicine to flow out of the infant medicine dispenser into the infant's mouth;

FIG. 8 illustrates an extension for enlarging an interior reservoir of the infant medicine dispenser; and

FIG. 9 is a second embodiment of the infant medicine dispenser.

### DETAILED DESCRIPTION

Referring now to the drawings, the infant medicine dispenser 10 includes a nipple 12 and a flange 14. The nipple 12 has a cross slit 16 which provides for a generally liquid tight seal and access to the interior reservoir 18 of the nipple 12. A cover 20 seals off an opening 22 after the liquid medicine is disposed within the interior reservoir 18. The liquid infant medicine dispenser 10 is now made ready to administer liquid medicine to the infant. The nipple 12 of the infant medicine dispenser is inserted into the infant's mouth. The sucking or stripping reflex of the infant is triggered which draws the liquid medicine from the interior reservoir 18 through the cross slit 16 and into the infant's mouth. If the infant inadvertently knocks the infant medicine dispenser 10 out of his/her own mouth, the liquid medicine will not spill since the cover 20 holds the liquid medicine within the interior reservoir 18 and the cross slit 16 is immediately closed once again. The adult can attempt a second administration by inserting the nipple 12 once again into the infant's mouth without having to guess how much liquid medicine the infant has already taken.

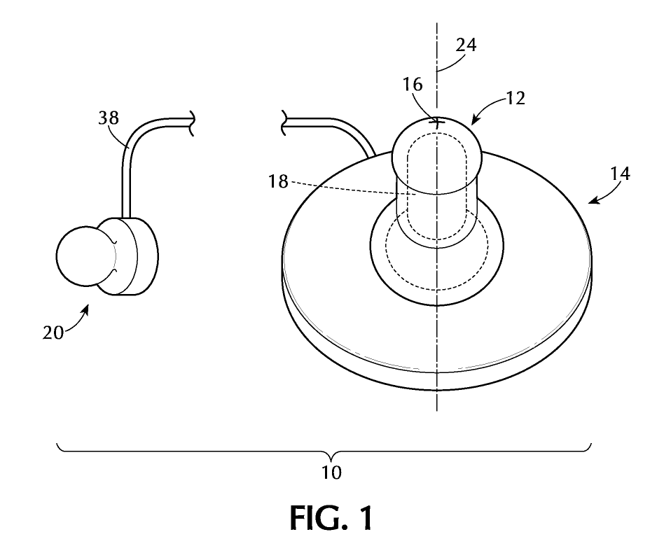

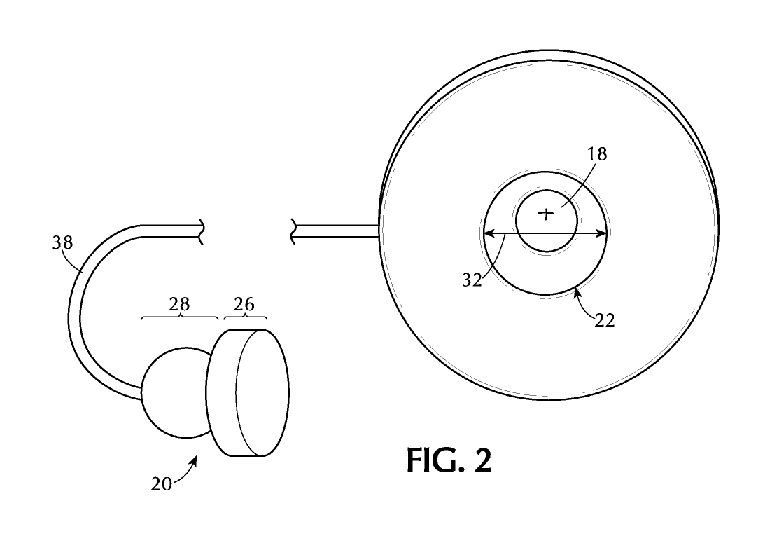

More particularly, the infant medicine dispenser 10 includes the nipple 12 and the flange 14. The flange 14 is generally larger than the infant's mouth so that the infant medicine dispenser 10 cannot be inadvertently swallowed by the infant. The flange 14 is preferably circular in shape, but may have any other shape such as square, triangular, octagonal, pentagonal, etc. The flange 14 is also generally perpendicular to a central axis 24 of the nipple 12. The nipple 12 protrudes from the flange 14 and is inserted into the infant's mouth when administering the liquid medicine. The nipple 12 may have a nipple configuration as shown in FIG. 1, but other shapes are also contemplated so long as the nipple 12 is insertable into the infant's mouth and the infant can latch onto the nipple 12. The nipple 12 additionally has a hollow interior defining the interior reservoir 18. The hollow interior reservoir 18 is better shown in FIG. 2. The hollow reservoir 18 is filled (e.g., poured, injected, etc.) with liquid medicine through opening 22. In the embodiment shown in FIGS. 1 and 2, the flange 14 and nipple 12 are integrally molded components. However, it is also contemplated that the flange 14 and nipple 12 may be separately formed and subsequently attached to each other through attachment methods known in the art or developed in the future.

When the liquid medicine is filled into the interior reservoir 18, the nipple 12 holds the liquid medicine therein. The nipple 12, at its distal tip, has an opening 16 which is normally closed but is open when the infant closes down on the nipple 12 with his/her tongue or begins to suck on the nipple 12. After filling the interior reservoir 18 with liquid medicine, an opening 22 at a rear side of the nipple 12 may be closed by a cover 20 disposable inside of the opening 22. The cover 20 may have a disc 26 and a handle 28. The user may grab the handle 28 and insert the disc 26 into the opening 20. The disc 26 may be sized and configured to the opening 22 so as to form a generally liquid tight seal there between.

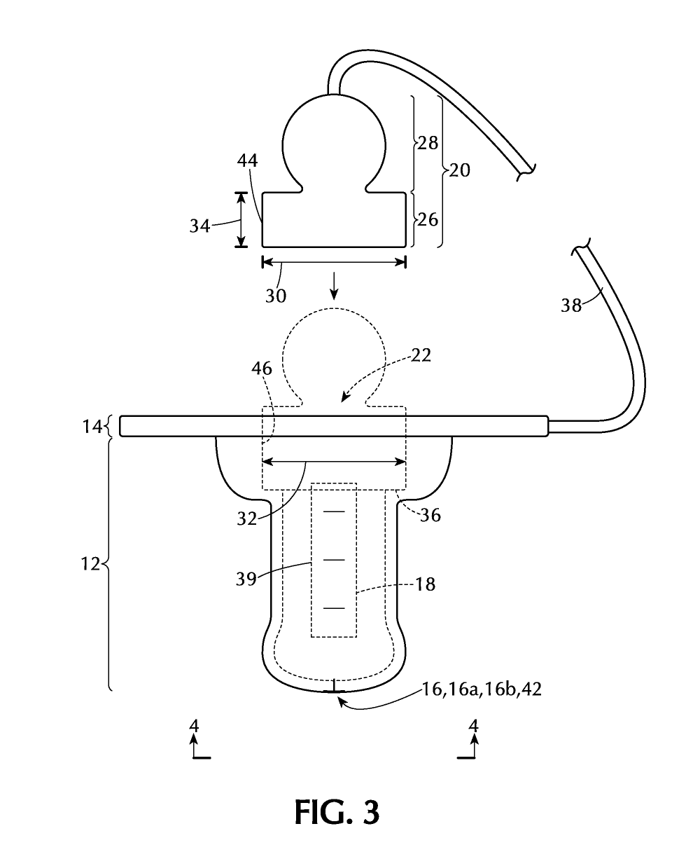

Referring now to FIG. 3, a diameter 30 of the disc 26 may be equal to or slightly greater than an inner diameter 32 of the opening 22 so as to form a generally liquid tight seal there between. The disc 26 preferably has a thickness 34 which is preferably equal to or greater than a depth of a ledge 36 formed in the interior reservoir 18. When the cover 20 is mounted to the opening 22, the handle 28 protrudes above the flange 14 so the user can grab the handle 28 and conveniently remove the cover 20 from the opening 22. The opening 22 and the disc 26 are shown as being circular. However, other configurations are also contemplated such as triangular, rectangular, pentagonal, octagonal, etc., so long as the disc 26 fits into the opening 22 and forms a generally liquid tight seal so that the liquid medicine does not spill out of the infant medicine dispenser 10 when the dispenser 10 falls or is inadvertently knocked out of the infants mouth.

The cover 20 may be secured to the flange 14 through a leash 38 so that the cover 20 does not become a chocking hazard.

Preferably, the nipple 12, flange 14, leash 38 and the cover 20 are all fabricated from a generally soft and flexible material such as silicone. However, other materials are also contemplated that are known in the art or designed in the future.

The nipple 12 may be generally semi-transparent so that a level of the liquid medicine within the interior reservoir 18 is viewable externally. The nipple 12 may additionally have graduations 39 which indicate the amount of fluid or liquid medicine within the liquid reservoir 18.

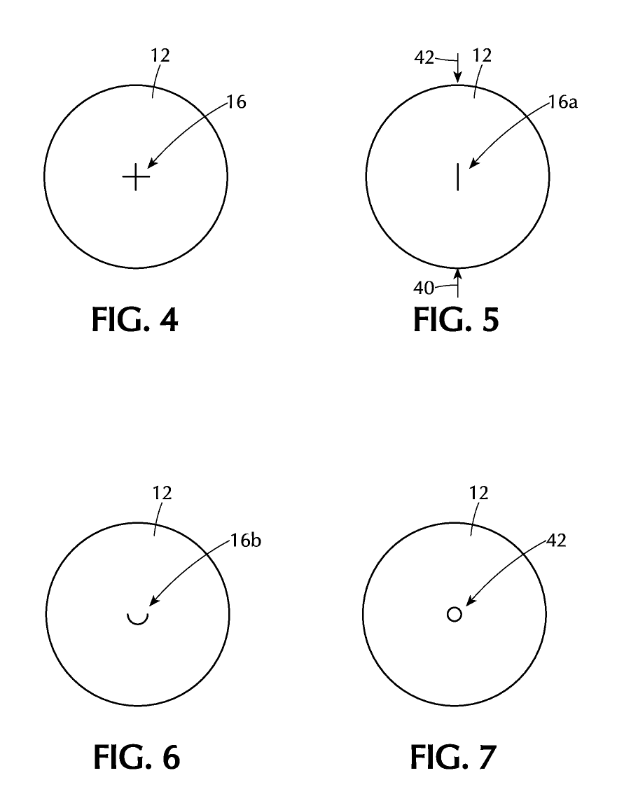

Referring now to FIG. 4, a front view of the nipple 12 is shown. The distal tip of the nipple 12 has a cross slit 16. Prior to insertion of the nipple 12 into the infants mouth, the cross slit 16 is sealed so that the liquid medicine contained within the interior reservoir 18 does not spill out of the cross slit 16. When the infant bites down on the nipple 12 or begins sucking, the cross slit 16 opens up and allows the liquid medicine to flow into the infant's mouth. Regardless of the angular orientation of the cross slit 16 with the infants mouth, the cross slit 16 will open up when the infant bites down on the nipple 12 or begins sucking. An alternate opening 16a is shown in FIG. 5. In particular, the slit 16a is a single vertical slit. In this embodiment, the nipple 12 is inserted into the infant's mouth so that the slit 16a is oriented in the vertical direction as shown in FIG. 5. When the infant bites down on the nipple 12, the slit 16a opens up and the liquid medicine begins to flow into the infant's mouth. Continuous sucking on the nipple 12 causes the infant to swallow the liquid medicine. In particular, the tongue pushes up the nipple 12 in the direction of arrow 40 while the top of the infant's mouth pushes down on the nipple 12 direction of arrow 42. If the nipple 12 is rotated 90° either clockwise or counter clockwise, then the compression of the nipple 12 by the infant's mouth would tend to close up the slit 16a. FIG. 6 shows a single curved slit 16b. In this embodiment, the slit 16b tends to open up regardless of the angular orientation of the nipple 12 with respect to the infant's tongue and mouth. In the embodiment shown in FIGS. 4-6, the slits 16, 16a, 16b provide a generally liquid tight seal. The nipple 12 being fabricated from a material such as silicone has an elasticity that allows the distal tip of the nipple 12 to spring back and conform back to its original shape after the slits 16, 16a and 16b are made.

In relation to FIG. 7, the distal tip may have an aperture 42. The aperture 42 may be sufficiently small so that liquid medicine inserted into or disposed within the interior reservoir 18 does not drip out of the aperture 42 due to capillary action.

In all of the embodiments shown in FIGS. 4-7, the slits 16, 16a, 16b and the opening or aperture 42 are capable of providing a substantial liquid tight seal when the infant medicine dispenser 10 is inverted and the liquid medicine is poured into or injected into the interior reservoir 18. The liquid itself creates pressure at the distal tip of the nipple 12 which urges the liquid medicine out of the slit 16, 16a, 16b and aperture 42. Nonetheless, the slit 16, 16a, 16b and the aperture 42 provide a substantially liquid tight seal. Liquid medicine may drip out of the slit 16, 16a, 16b and the aperture 42, but such drip is at such a slow pace, that it is still considered to be a liquid tight seal at the distal tip of the nipple 12.

During use, the infant medicine dispenser 10 is utilized to administer liquid medicine to an infant. The cover 20 is removed from the opening 22. The nipple 12 is inverted so that the nipple 12 is pointed downward and the opening 22 is pointed upward. At this point, the slit 16, 16a, 16b are in the normally closed position. The liquid medicine is poured, injected or otherwise disposed within the interior reservoir 18 by way of the opening 22. The weight of the liquid medicine urges the liquid medicine out through the slits 16, 16a, 16b and the aperture 42. However, the slits 16, 16a, 16b are closed so as to form a liquid tight seal. With respect to the aperture 42 shown in FIG. 7, the capillary action between the liquid medicine and the nipple 12 may be sufficient to overcome the pressure caused by the weight of the liquid medicine disposed within the interior reservoir 18.

As shown in FIG. 3, the nipple 12 may have graduations 39 which indicate the amount of liquid medicine within the interior reservoir 18. The user disposes the proper dosage of liquid medicine within the interior reservoir 18. If the interior reservoir 18 is too small, then the infant medicine dispenser 10 may be loaded any multiple thereof necessary to satisfy the dosage amount and given to the infant. By way of example and not limitation, if the interior reservoir 18 holds 1 ml, and a 2 ml dosage is required, the user may load the infant medicine dispenser 10 with one 1 ml and administer that 1 ml to the infant, then repeat the process one more time to reach the 2 ml dosage.

After the liquid medicine is disposed within the interior reservoir 18 the cover 20 is disposed or inserted into the opening 22. As shown in FIG. 3, the user may grab the handle 28 and insert the disc 26 into the opening 22 until the disc 26 contacts the ledge 36 formed within the interior reservoir 18 of the nipple 12. The cover 20 prevents spillage of the liquid medicine in the event that the infant inadvertently knocks the infant medicine dispenser 10 out of his/her own mouth or from the user's hands. The infant medicine dispenser 10 may be tilted at different angles that is convenient to the infant, so that the infant medicine dispenser 10 may be positioned properly with respect to the infant's mouth. Slits 16, 16a, 16b or the aperture 42 prevent liquid medicine from secreting out of the distal end of the nipple 12. The cover 20 prevents liquid medicine from spilling out of the interior reservoir 18 through the opening 22. The nipple 12 is inserted into the infant's mouth. The infant begins to suck the liquid medicine within the interior reservoir 18 through the slits 16, 16a and 16b and the aperture 42. If the infant inadvertently knocks the infant medicine dispenser out of his/her own mouth or the hand of the adult, then the liquid medicine stays in the reservoir 18. Also, since the infant medicine dispenser 10 encourages the infant to continue sucking, the infant is less likely or does not spit out the administered liquid medicine.

Optionally, the disc 26 of the cover 20 may be configured to form an air tight seal with the opening 22. By way of example and not limitation, the exterior surface 44 of the disc 26 may be smooth. Also, an interior smooth surface 46 of the interior reservoir 18 may be smooth. The diameter 30 of the disc 26 may be slightly larger than the interior diameter 32 of the opening 22 so that the disc 26 fits snuggly within the opening 22. A small air leak may exist. However, the infant would still be able to create suction when sucking on the nipple 12. Other ways of creating an air tight seal between the disc 26 and the opening 22 is contemplated such as by forming a thread on the exterior surface 44 of the disc 26 that mate with a thread formed on the interior surface 46 of the opening 22.

After use, the cover 20 may be removed from the opening 22 by grabbing the handle 28 and pulling the cover 20 off of the opening 22. The infant medicine dispenser 10 may be washed or sterilized for subsequent.

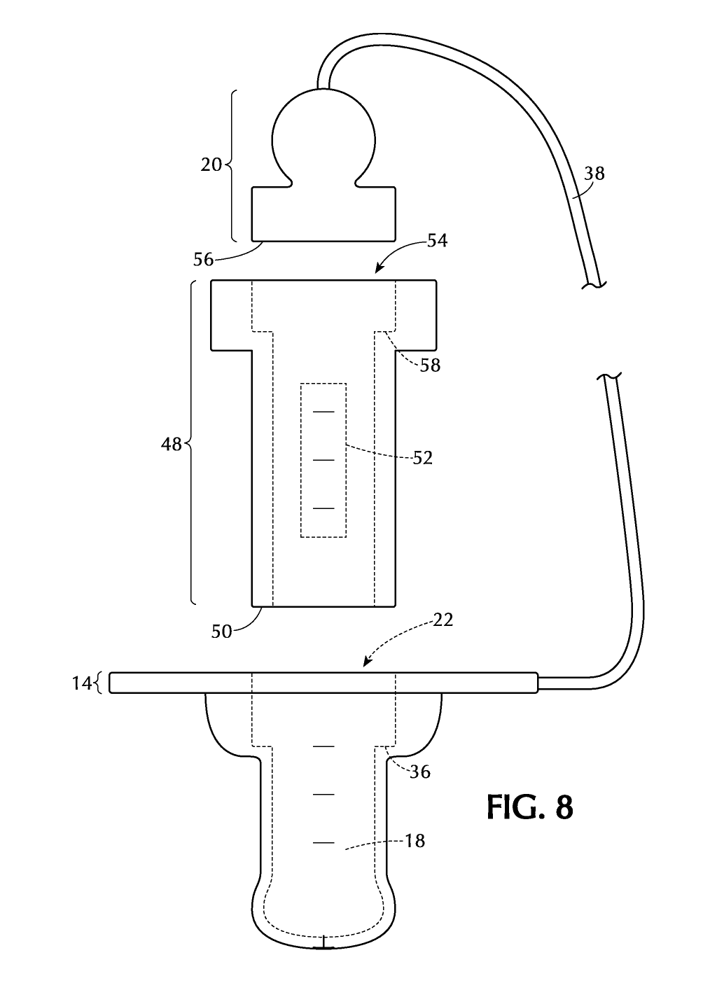

Referring now to FIG. 8, an optional extension 48 may be inserted into the opening 22. The extension 48 may have a tubular construction and mount to the opening 22 so as to form a water tight seal or liquid tight seal there between. The extension 48 increases the capacity of the interior reservoir 18. The extension 48 may be inserted into the opening 22 until a bottom end 50 contacts ledge 36. The extension 48 may additionally have graduations 52. The top end of the extension 48 may also have an opening 54 which receives cover 20. The cover 20 may be inserted into the opening 54 until the bottom end 56 contacts the ledge 58. The cover 20 may be attached and secured to the flanged 14 by leash 38. If the dosage amount exceeds the total capacity of the infant medicine dispenser 10 even with the extension 48, multiple administrations may be made until the proper dosage is reached.

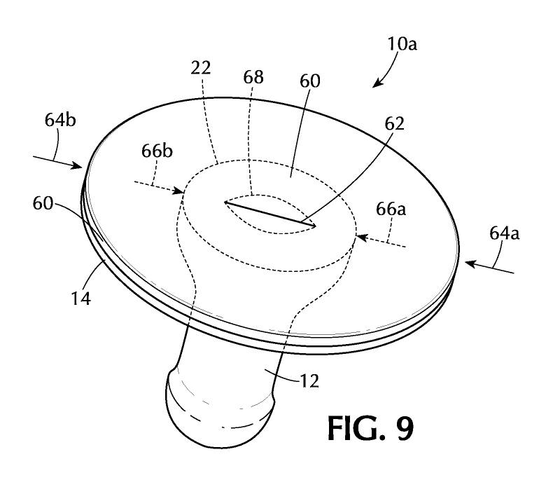

Referring now to FIG. 9, a second embodiment of the infant medicine dispenser 10a is shown. Instead of a removable attachable cover 20, the opening 22 is covered by a flexible membrane 60. The flexible membrane has a slit, or elongate slit 62 which can be opened by squeezing either the flange 14 in the direction of arrows 64a, b, or squeezing the base of the nipple 12 as shown by arrow 66a, b. The forces 66a, b and 64a, b are aligned to the direction of the straight linear slit 62 formed in the flexible membrane 60. The flexible membrane 60 may be a silicone sheet of material which may be attached to the flange 14. When the user squeezes the flange 14 or the base of the nipple 12, the slit 60 opens up as shown by dash lines 68. The user may not fill the interior reservoir with liquid medicine. As soon as the user releases pressure, the slit is traversed to the closed position. In this embodiment, the slit 62 may be sufficiently closed so that the infant is able to create at least a partial vacuum when sucking on the nipple 12.

The above description is given by way of example, and not limitation. Given the above disclosure, one skilled in the art could devise variations that are within the scope and spirit of the invention disclosed herein, including various ways of forming the dispenser. Further, the various features of the embodiments disclosed herein can be used alone, or in varying combinations with each other and are not intended to be limited to the specific combination described herein. Thus, the scope of the claims is not to be limited by the illustrated embodiments.

1. An infant medicine dispenser comprising:
a pacifier defining a nipple and a flange, the flange attached to a base of the nipple, the nipple having a cross-slit at a distal tip of the nipple, the nipple having an interior reservoir with an opening opposite the distal tip of the nipple, a thickness of the distal tip of the nipple at the cross-slit having a constant thickness with internal surfaces pressed against each other to form a generally liquid tight seal so that liquid medicine stored in the reservoir does not leak out of the nipple while filling the reservoir with the liquid medicine and while the infant latches onto the nipple;
a cover sized and configured to plug the opening of the nipple so that the liquid medicine does not spill if the pacifier is inadvertently dislodged from the infant's mouth;
wherein the liquid medicine generally flows out of the reservoir into the infant's mouth after the infant latches onto the nipple and begins to suck on the nipple.

2. (canceled)

3. (canceled)

4. (canceled)

5. The dispenser of claim 2 wherein the slit is the cross slit which opens up when the infant begins to suck on the nipple regardless of an angular orientation of the nipple.

6. (canceled)

7. The dispenser of claim 1 wherein the cover is removably attached to the opening of the nipple.

8. The dispenser of claim 1 wherein the cover is integral with the pacifier.

9. The dispenser of claim 1 wherein the cover has a slit which is normally closed and capable of being traversed to an opened position by squeezing the pacifier.

10. The dispenser of claim 1 wherein the interior reservoir of the nipple holds three (3) ml.

11. The dispenser of claim 1 wherein the nipple is at least semi transparent and the nipple has graduations for indicating an amount of liquid medicine in the nipple.

12. The dispenser of claim 1 wherein the opening of the interior reservoir has threads, and the dispenser further comprises a tube threadably engageable to the threads of the interior reservoir to enlarge a capacity of the interior reservoir.

13. The dispenser of claim 12 wherein the cover is removably attached to a proximal end of the tube.

14. The dispenser of claim 12 wherein the tube extends past the flange opposite the nipple.

15. The dispenser of claim 12 wherein the tube has graduations for indicating an amount of liquid medicine in the nipple and the tube.

16. The dispenser of claim 1 further comprising a tube integrally formed with the flange on an opposite side of the nipple to enlarge a capacity of the interior reservoir.

17. A method of dispensing medication to an infant, the method comprising the steps of:
providing an infant medicine dispenser comprising:
a pacifier defining a nipple and a flange, the flange attached to a base of the nipple, the nipple having a cross-slit at a distal tip of the nipple, the nipple having an interior reservoir with an opening opposite the distal tip of the nipple, a thickness of the distal tip of the nipple at the cross-slit having a constant thickness with internal surfaces pressed against each other to form a generally liquid tight seal so that liquid medicine stored in the reservoir does not leak out of the nipple while filling the reservoir with the liquid medicine and while the infant latches onto the nipple;
a cover sized and configured to plug the opening of the nipple so that the liquid medicine does not spill if the pacifier is inadvertently dislodged from the infant's mouth;
wherein the liquid medicine generally flows out of the reservoir into the infant's mouth after the infant latches onto the nipple and begins to suck on the nipple;
removing the cover;
filling the interior reservoir with liquid medicine; and
administering the liquid medicine to the infant.
